(19) United States
(12) Patent Application Publication
(10) Pub. No.: US 2002/0070043 A1
(43) Pub. Date: Jun. 13, 2002

(54) Casing used in outdoors

(75) Inventor: Yasuhiro Kitajima, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 10/006,362

(22) Filed: Dec. 10, 2001

(30) Foreign Application Priority Data
Dec. 8, 2000 (JP) 2000-375149

(51) Int. Cl. H02G 3/08

(52) U.S. Cl. 174/50

(57) ABSTRACT

A casing used in the outdoors is composed of a body which is provided with suspending units for suspending the body from a wire stretched over the ground and has openings situated opposite to each other, and covers for covering the openings of the body. The body is shaped into a tubular configuration having a predetermined cross-section. The body is provided with gaskets on contact surfaces which are respectively formed on peripheries of the openings of the body, and brought into contact with the covers. The covers are respectively fitted to the body via hinges so as to be rotational therearound. The body is provided with supporting members situated in the inside space of the body, and electronic circuit units are fitted to the supporting members.

### FIELD OF THE INVENTION

The invention relates to a casing used in the outdoors, and especially to a casing used in the outdoors which is suspended from a wire (for example, a wire which is called a messenger wire and stretched over the ground), and accommodates a communication apparatus of various kinds, such as a community antenna television (CATV) repeater.

### BACKGROUND OF THE INVENTION

Hitherto, communication apparatuses of various kinds, such as repeaters for amplifying attenuated communication signals, have been used in communication through wire using cables. The casings of various kinds have been developed with the object of accommodating those communication apparatuses.

FIG. 1 shows a typical example of the conventional casing 120 which is suspended from a wire stretched together with a cable via suspending units 125 and used in the outdoors.

The casing 120 is composed of a body 122 having an opening (not shown) through which electronic parts (electronic circuit units, hereinafter) are accommodated in the body 122, and a cover 121 for covering the front of the body 122.

The cover 121 is shaped into a box-like configuration, and an opening of the cover 121 faces the body 122. The cover 121 is fitted to the lower edge of the body 122 via a hinge (not shown) so that the cover 121 is rotational around the hinge.

After the cover 121 is shut, the cover 121 is fixed to the body 122 by means of fixing units 123 which are formed of bolts and situated on the upper edge of the body 122 so that the cover 121 covers the front of the body 122.

Since the cover 121 is brought into contact with a contact surface 124 which is formed on the periphery of the opening of the body 122, the waterproof property of the casing 120 can be assured, and the inside space of the casing 120 is prevented from being submerged by rainwater.

The body 122 is also shaped into a box-like configuration, and the opening of the body 122 faces the cover 121. The body 122 accommodates the electronic circuit units in the inside space thereof.

Moreover, the body 122 is provided with the two suspending units 125 which are respectively situated on both the side ends of the top surface of the body 122 and project upward.

Since the casing 120 is used in the outdoors, the cover 121 and the body 122 are formed of plastics or aluminum in consideration of physical strength, heat-radiation property, heat-resisting property against rays of the sun, and lightness.

The cover 121 and the body 122 are manufactured by molding process with the objects of preventing the inside space of the casing 120 from being submerged by rainwater, and of reducing manufacturing cost, and neither sheet metal processing nor cutting is used in the aforementioned process.

In the aforementioned casing 120, the electronic circuit units (not shown) are packaged in the inside space of the body 122 or the cover 121 in a state that the cover 121 is opened.

Moreover, the electronic circuit units packaged in the casing 120 are electrically connected with cables inserted into the inside space of the body 122 through the side surfaces of the body 122.

Thereupon, with the spread of the communication apparatuses of the various kinds including the CATV repeaters and the development of the communication technology, the casing having a large capacity becomes necessary frequently.

In such a case, it has been the conventional technique that the dimensions of the casing, such as the length, the height, and the depth, are simply increased maintaining the former structure thereof, and the electronic circuit units are accommodated in the large-sized casing.

Moreover, in case that the casing is suspended from the wire, if the heights of the cover and the body are increased, there arises incommodity that a space occupied by the casing is enlarged centering around the wire, so that the casing has been enlarged by increasing the dimension in the depth direction in order to avoid the aforementioned incommodity.

However, since the cover and the body of the casing used in the outdoors are manufactured by molding process using the metallic mold in most cases, if the cover and the case are simply enlarged, it becomes necessary to mold the body in such a condition that tapers formed on the inner surfaces of the body cannot be disregarded.

Accordingly, in case that the dimension of the body in the depth direction is increased, since the cross-sectional dimension of the body decreases as the distance from the opening of the body increases, it becomes difficult to package the large-sized electronic circuit in the body, and the electronic circuit units cannot be accommodate in the casing efficiently.

Moreover, in case that electronic circuit units are fitted to the inner part of the body and the other electronic circuits units are further fitted to the front part of the body in order to accommodate the electronic circuit units in the body efficiently, if the electronic circuit units fitted to the inner part of the body are inspected or replaced, it becomes necessary to remove the electronic units fitted to the front part of the body, and the operation efficiency in maintenance is deteriorated.

Generally speaking, in case that the large scale electronic circuit units are packaged in the inside spaces of the cover and the body, since the number of electrical connections between these electronic circuit units increases, the number of cables necessary for these electrical connections increases inevitably.

In case that the number of the cables for intermediating between the electronic circuit units increases, there arises an apprehension that the cables will be put between the body and the cover when the cover is shut, and the waterproof property of the casing will be deteriorated as a result.

### SUMMARY OF THE INVENTION

Accordingly, it is an object of the invention to provide a casing used in the outdoors which accommodates electronic circuit units with high efficiency, is suited for actual works in manufacturing and maintenance, and prevents the waterproof property of a casing from being deteriorated because of intromission of cables.

According to the feature of the invention, a casing used in the outdoors comprises:

a body which is provided with one or more suspending means for suspending the body from a wire stretched over a ground, and has openings situated opposite to each other, and

covers for covering the openings of the body.

According to the aforementioned structure, since the electronic circuit units can be packaged in the body through the openings respectively formed on the front and rear sides of the body, the operation efficiency at the time of manufacturing or inspection can be heightened.

In order to achieve the object of the invention, the body is shaped into a tubular configuration having a predetermined cross-section.

Since the metallic mold fitting the body is used in the step of molding the body, tapers formed on inner surfaces of the body can be satisfactorily reduced, and the decrease for the cross-section of the body can be disregarded, so that the large-scale electronic circuits can be packaged in the body without hindrance, and the many electronic circuit units can be accommodated in the casing efficiently.

In order to achieve the object of the invention, the body is provided with gaskets on contact surfaces which are respectively formed on peripheries of the openings of the body, and brought into contact with the covers.

According to the aforementioned structure, the waterproof property of the contact surfaces formed between the body and the covers can be improved.

In order to achieve the object of the invention, the covers are respectively fitted to the body via hinges.

According to the aforementioned structure, the operation efficiency in the step of packaging the electronic circuit units in the inside spaces of the covers can be improved, and the covers can be shut easily.

In order to achieve the object of the invention, the body is provided with supporting members situated in an inside space of the body, and electronic parts are fitted to the supporting members.

According to the aforementioned structure, the inside space of the body can be utilized effectively, and the electronic circuit units can be packaged in the body with high efficiency.

In order to achieve the object of the invention, the electronic parts are fitted to the supporting members via fitting boards which can be easily fitted to and removed from the supporting members.

According to the aforementioned structure, since the electronic circuit units can be accommodated in the body in such a condition that the electronic circuit units are fitted to the fitting boards, the efficiency in accommodating the electronic circuit units can be further heightened.

In order to achieve the object of the invention, electronic parts are packaged in inside spaces of the covers.

### BRIEF DESCRIPTION OF DRAWINGS

The invention will be explained in more detail in conjunction with appended drawings, wherein:

FIG. 1 is a perspective view for showing an outline of a structure of a conventional casing used in the outdoors,

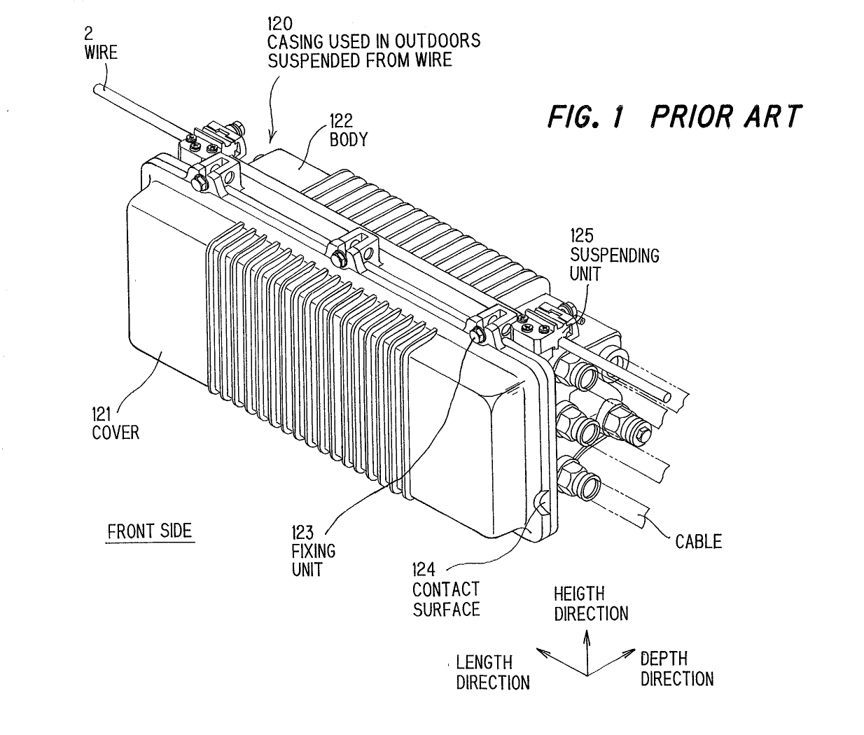

FIG. 2 is a perspective view for showing an outline of a structure of a casing used in the outdoors according to a preferred embodiment of the invention,

FIG. 3 is a perspective view for showing an outline of a structure of a casing used in the outdoors according to a preferred embodiment of the invention in such a state that two covers thereof are opened,

FIG. 4 is a perspective view for explaining important parts of gaskets and a fitting board used in a casing used in the outdoors according to a preferred embodiment of the invention,

FIG. 5 is a perspective view for explaining a procedure for packaging electronic circuit units in a casing used in the outdoors according to a preferred embodiment of the invention,

FIG. 6 is a perspective view for explaining a procedure for packaging electronic circuit units in a casing used in the outdoors according to a preferred embodiment of the invention,

FIG. 7 is a perspective view for explaining inside spaces of covers and a body of a casing used in the outdoors according to a preferred embodiment of the invention, and

FIG. 8 is a perspective view for explaining inside spaces of covers and a body of a casing used in the outdoors according to a preferred embodiment of the invention.

### DESCRIPTION OF PREFERRED EMBODIMENT

Hereafter, a casing used in the outdoors according to a preferred embodiment of the invention will be explained referring to appended drawings.

Although the casing used in the outdoors according to the embodiment of the invention is designed for a communication apparatus, such as a CATV repeater, suspended from a wire in the following explanation, the field of application of the invention is never restricted to the aforementioned appliance.

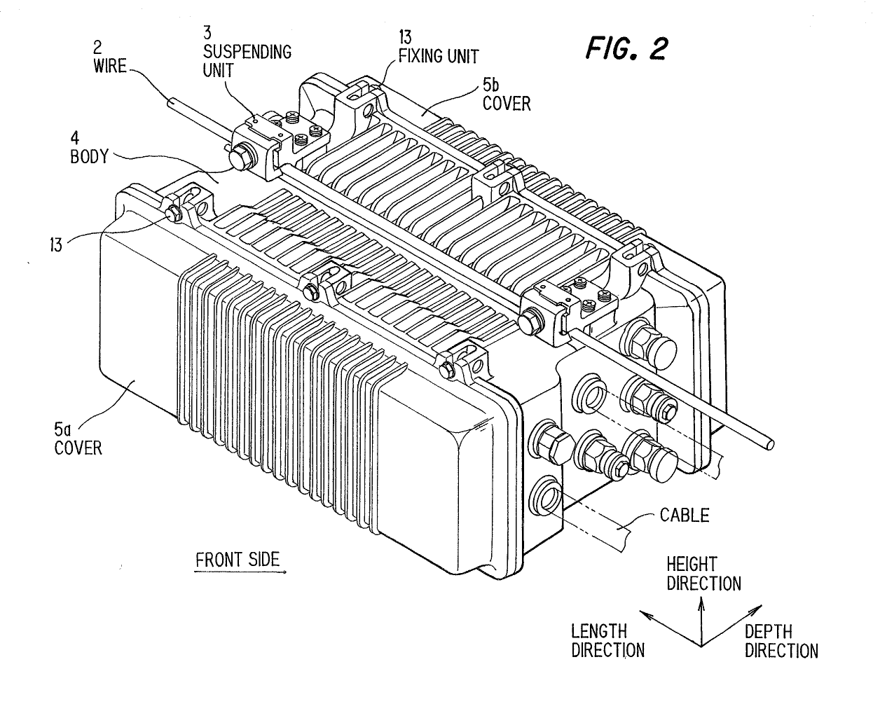

FIG. 2 is a perspective view for explaining an outline of the casing used in the outdoors according to the preferred embodiment of the invention.

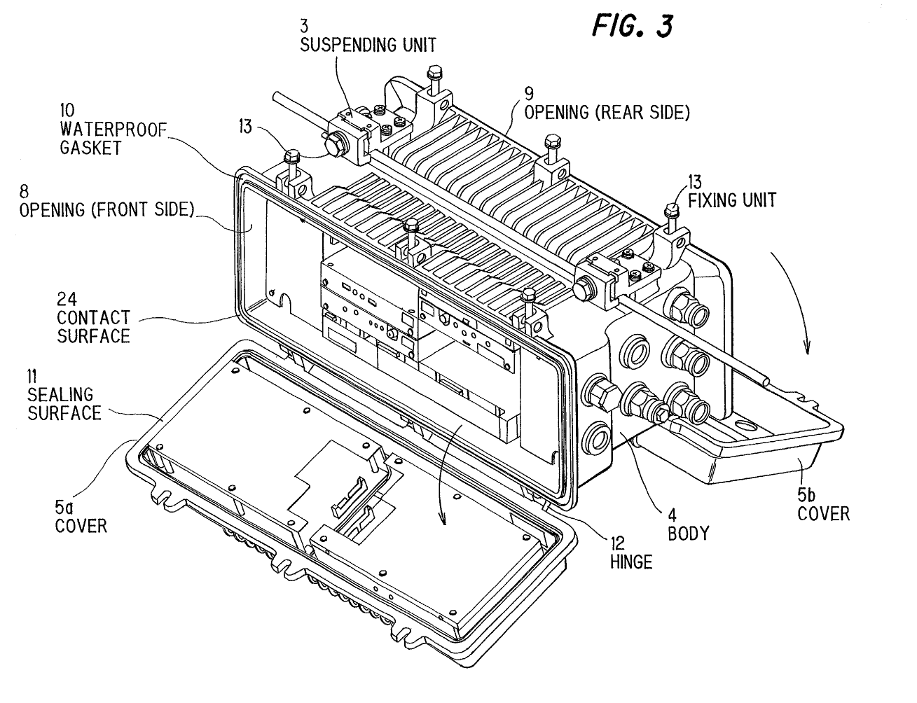

Moreover, FIG. 3 is a perspective view for showing the structure of the aforementioned casing used in the outdoors according to the embodiment in such a condition that two cover thereof are opened.

The casing used in the outdoors shown in FIGS. 2, 3, is suspended from a wire 2 stretched over the ground, and composed of suspending units 3 for suspending the casing from the wire 2, a body 4 which is shaped into a tubular configuration having a predetermined cross-section and has openings 8, 9 at front and rear ends thereof, and covers 5a, b for covering the openings 8, 9.

The body 4 and the covers 5a, 5b are formed of lightweight, rigid, and heat-resisting material, such as plastics or aluminum, and proof against environmental conditions, such as direct rays of the sun, or wind and rain.

Moreover, since the body 4 and the covers 5a, 5b are molded by using the metallic mold, manufacturing cost can be reduced when they are mass-produced.

The body 4 is shaped into a tubular configuration, the cross-sectional view of which is almost rectangular. Moreover, the openings 8, 9 are respectively formed at the front and rear ends of the body 4. The top and bottom surface of the body 4 are respectively provided with fins for improving the radiation efficiency of heat generated in the body 4. Both the side surfaces of the body 4 are respectively provided with through holes for passing the cables and closing plugs.

Moreover, since the openings 8, 9 are respectively formed at the front and rear ends of the body 4, it is easy to get access to the electronic circuit units through the openings 8, 9, when the electronic circuit units are packaged in the inner part of the body 4, or those packaged in the body 4 are inspected or replaced, so that the operation efficiency in manufacturing or maintenances can be improved.

Moreover, even in case that the dimension of the depth of the body 4 is increased in order to accommodate the large-sized electronic circuit units efficiently, since the openings 8, 9 are formed at both the front and rear ends of the body 4, the step of molding the body 4 can be carried out smoothly, and tapers formed on inner surfaces of the body 4 can be made slight.

Accordingly, since the decrease of the cubic volume of the body 4 can be disregarded, the inside space of the body 4 is approximately shaped into a rectangular parallelepiped, and incommodity that the large-sized electronic circuit units become hard to be accommodated in the body 4 is dissolved.

The top surface of the body 4 is provided with the suspending units 3 at both the side ends of the body 4. The suspending units 3 suspend the body 4 from the wire 2 stretched in the transverse direction.

According to the aforementioned structure, since the cables spread almost in parallel with the wire 2 can be taken in the body 4 without being drawn around uselessly, the cost of the cables can be reduced.

Still more, in order to prevent the casing from being suspended from the wire 2 obliquely, it is necessary that a vertical line which passes through the center of gravity of the casing intersects the central axis of the wire 2. From this point of view, it is desirable to construct the suspending units 3 so that the positions of them relative to the center of gravity of the casing can be adjusted on the top surface of the body 4. According to the aforementioned structure, even in case that the center of gravity of the casing deviates from its ordinary position because of an alternation of the arrangement of the electronic circuit units packaged in the casing, incommodity that the casing is suspended from the wire 2 obliquely can be avoided.

As shown in FIG. 3, the covers 5a, 5b are respectively fitted to the front and rear edges of the bottom surface of the body 4 via hinges 12 so as to be rotational therearound, and each of the hinges 12 is fixed to the body 4 at three positions leaving the same distance. Moreover, after the covers 5a, 5b are shut, they are respectively fixed to the front and rear edges of the top surface of the body 4 by means of fixing units 13, each of which is formed of a bolt and a nut. The three fixing units 13 form a line along the front or rear edge edge of the top surface of the body 4 at the same interval.

Moreover, the method for fitting the covers to the body is never restricted to that using the hinges, and the method in which the covers can be removed at need may be adopted. In case that the hinges are used so that the covers are rotational therearound, the directions of the rotations of the covers are never restricted to the up-and-down direction, and the rotation in the right-and-left direction may be selected.

According to the aforementioned structure, since the covers 5a, 5b are fitted to the body 4 via the hinges 12 so as to be rotational therearound, the operation for packaging the electronic circuit units in the inside spaces of the covers 5a, 5b can be smoothly performed, and the covers 5a, 5b can be shut easily.

Moreover, as shown in FIG. 3, since a sealing surface 11 formed on the periphery of the cover 5a is pressed against a contact surface 24 formed on the periphery of the opening 8 at uniform pressure approximately, the sealing property of the casing is improved, and the waterproof property of the same can be heightened. A similar effect can be also achieved at the opening 9.

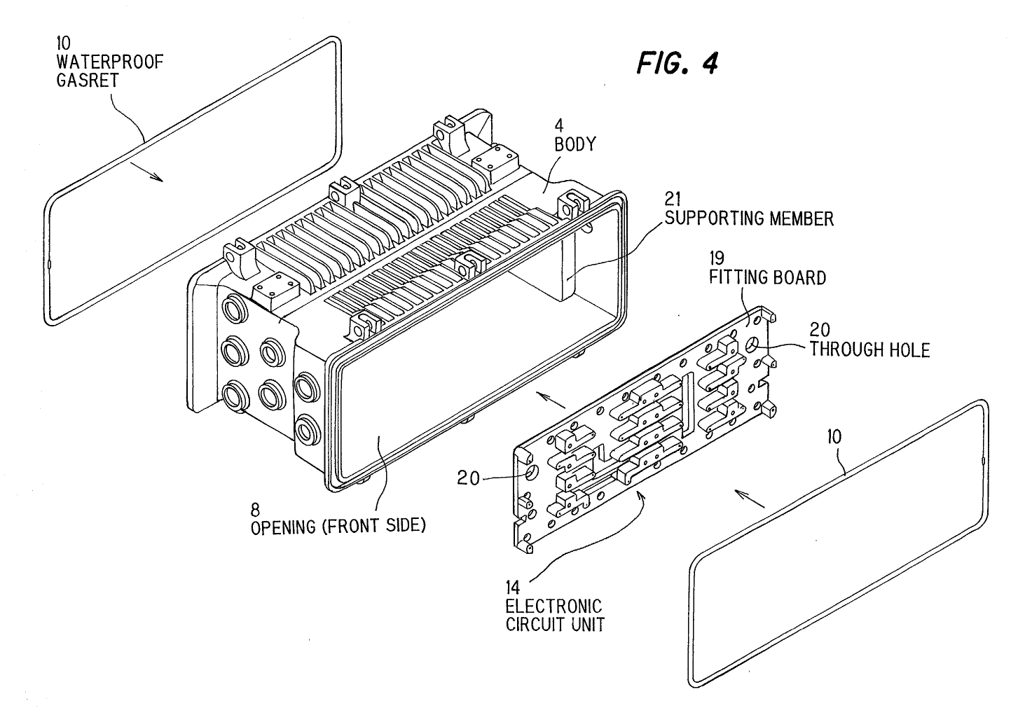

As shown in FIGS. 3, 4, it is desirable that a waterproof gasket 10 is provided for the contact surface 24. According to the aforementioned structure, the waterproof property of the contact surface 24 lying between the body 4 and the cover 5a or 5b can be further heightened.

The waterproof gasket is formed of waterproof material, and shaped into a ring-like configuration. For example, an O-ring formed of heat resisting rubber or a rubber packing shaped into a sheet is suited for the purpose.

As shown in FIG. 4, it is desirable that the body 4 is provided with fitting boards 19 to which the electronic circuit units are fitted. According to the aforementioned structure, since the number of the fitting boards 19 can be increased or decreased in accordance with the thickness of the electronic circuit units 14, the electronic circuit units 14 can be accommodated in the body 4 with high efficiency.

The fitting board 19 can be fitted to and removed from the supporting member 21 by means of screws.

Since through holes 20 are formed on the fitting board 19, wiring routes are not hindered by the fitting board 19, and the fitting board 19 is fitted with the electronic units 14 with high density. For example, all the electronic circuit units can be packaged in the inside space of the body 4.

The electronic circuit units packaged in the inside space of the body 4 can be electrically connected with the cables in such a condition that wiring distances are short.

Accordingly, it is desirable to increase the number of the electronic circuit units packaged in the body 4 so far as possible by utilizing the fitting boards 19. If the electronic circuit units are packaged in the body 4 in this way, since the number of the electronic circuit units packaged in the inside spaces of the covers 5a, 5b can be decreased to the utmost limit, the amount of the cables inserted between the body 4 and the covers 5a, 5b can be decreased, and the cost of the cables and material necessary for the wirings can be decreased. Still more, it is the most desirable that the electronic circuit units are not packaged in the inside spaces of the covers 5a, 5b.

If the amount of the cables inserted between the covers 5a, 5b and the body 4 is decreased, incommodity that the cables may be put between the covers 5a, 5b and the body 4 when the covers 5a, 5b are opened or shut can be lightened, and an apprehension that water will enter the body 4 because of intromission of the cables can be eliminated, hence the reliability of the waterproof property of the casing can be heightened.

As shown in FIG. 3, the cover 5a is also shaped into a box-like configuration, and has an opening at the front of thereof which faces the body 4. The sealing surface 11 is formed on the periphery of the front of the cover 5a so as to brought into contact with the contact surface 24 of the body 4 by means of the fixing units 13, hence the waterproof property of the casing can be secured. The aforementioned explanation holds also for the cover 5b formed on the rear end of the body 4.

If the electronic circuit units are packaged in the inside spaces of the covers 5a, 5b, the internal space of the casing can be fully utilized, and the efficiency of the process for packaging the electronic circuit units in the casing can be heightened as a whole.

Still more, it is desirable that the electronic circuit units in which the amounts of the wirings are small are packaged in the inside spaces of the covers 5a, 5b. If the aforementioned measure is taken, an apprehension that the cables will be put between the covers 5a, 5b and the body 4 is lightened.

Since the cubic volume of the inside space of the body 4 is larger than those of the covers 5a, 5b in the ordinary casing, it is desirable to determine the arrangement of the electronic circuit units in consideration of the configurations and the sizes of the electronic circuit units.

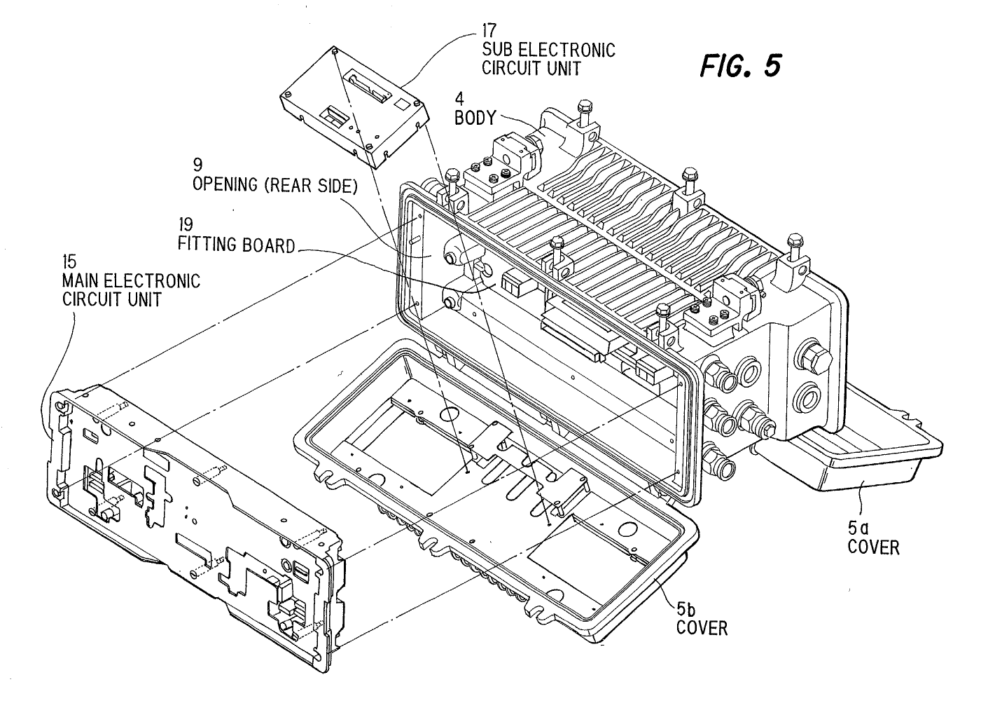

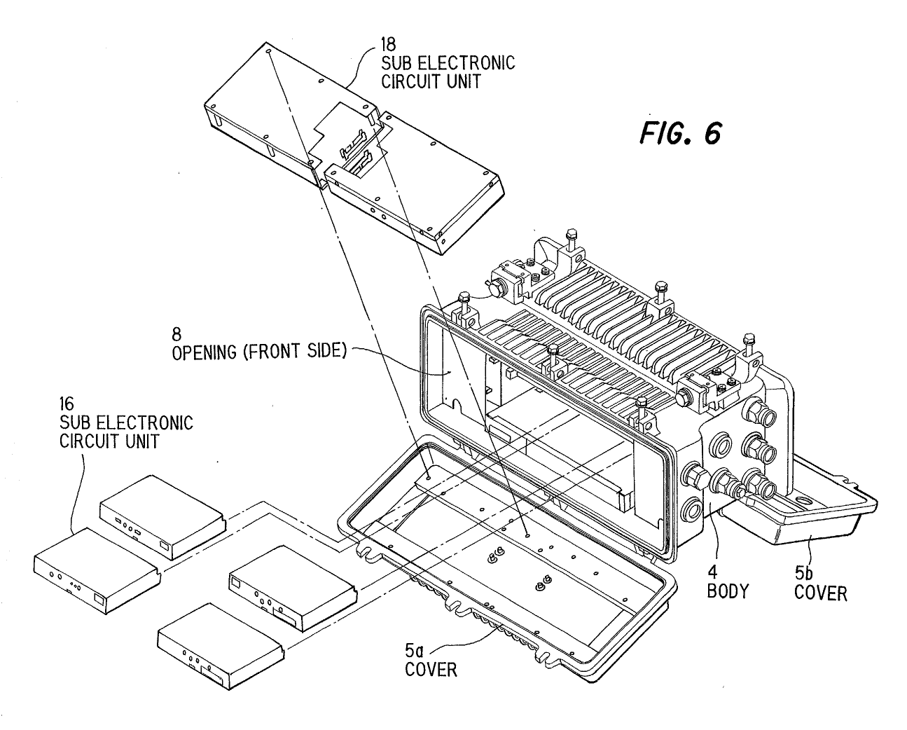

For example, in case that a large-sized electronic circuit unit and plural small-sized sub electronic circuit units are packaged in the body 4, the large-sized main electronic circuit unit 15 can be packaged at the rear opening 9 as shown in FIG. 5, and the small-sized sub electronic units 16 can be packaged at the front opening 8 in such a condition that they are stacked up as shown in FIG. 6.

According to the aforementioned structure, since the electronic circuit units 15, 16 can be packaged in the body 4 through both the front and rear openings 8, 9, these electronic circuit units can be packaged in the body 4 efficiently.

Moreover, since the inside space of the body 4 is almost shaped in a rectangular parallelepiped, the sub electronic circuit units 16 can be packaged in such a condition that they are stacked up inside the body 4, hence the efficiency in accommodating the electronic circuit units can be heightened.

Moreover, it is desirable to package the sub electronic circuit units in the inside spaces of the covers 5a, 5b. For example, the sub electronic circuit unit 17 may be packaged in the inside space of the rear cover 5b as shown in FIG. 5, and the two sub electronic circuit units 18 may be packaged in the inside space of the front cover 5a side by side as shown in FIG. 6. According to the aforementioned structure, since the inside spaces of the front and rear covers 5a, 5b can be used effectively, the efficiency in accommodating the electronic circuit units 17, 18 can be further heightened.

As shown in FIG. 5, since the large-sized and heavy electronic circuit unit 15 is packaged in the inside space of the body 4, the lightweight covers 5a, 5b of small depths can be adopted and the covers 5a, 5b can be opened or shut easily and safely.

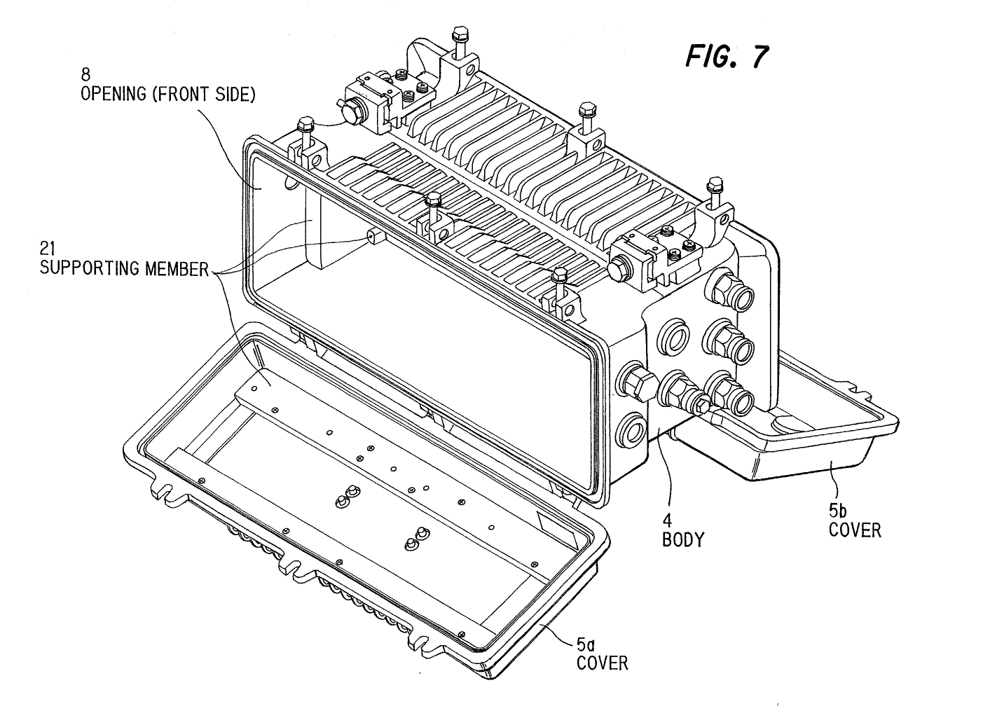

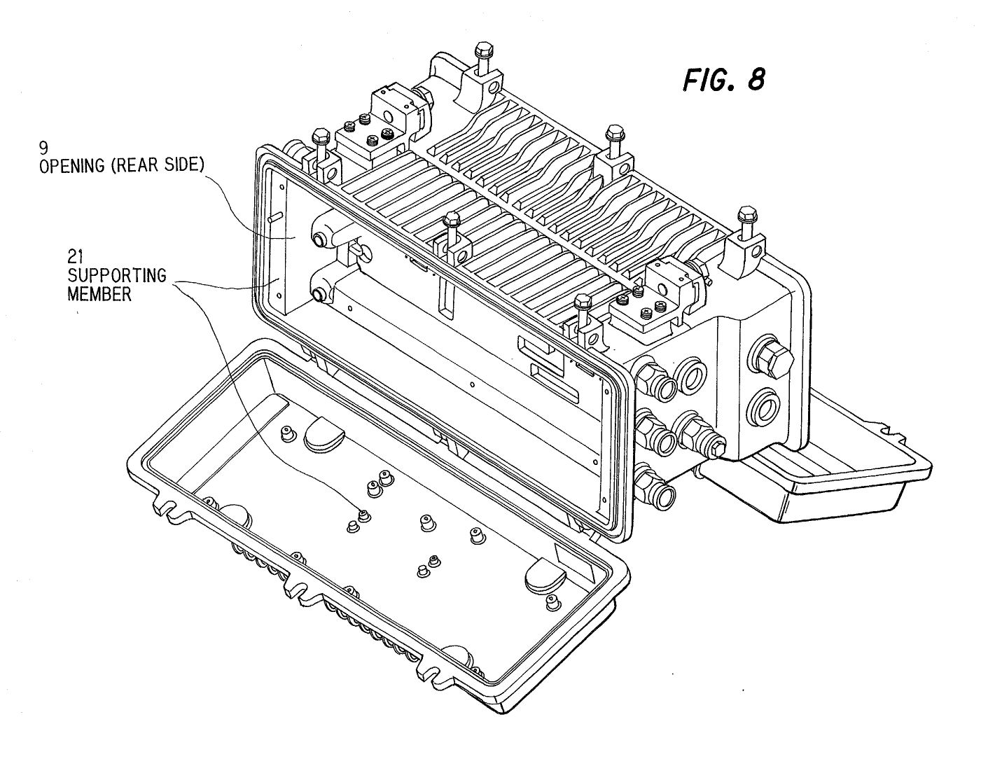

Still more, as shown in FIGS. 7, 8, since the body 4 and the covers 5a, 5b are respectively provided with the supporting members 21 on which female screws for fixing the electronic circuit units in combination with mail screws are formed, and the fitting board 19 (see FIG. 4) is shaped so as to be fitted to the supporting member 21, the electronic unit 16 having particular dimensions can be packaged in the casing by means of the fitting board 19 smoothly.

As mentioned in the above, according to the casing according to the invention, the fitting boards 19 are provided in the inside space of the body 4, the large-sized main electronic circuit unit 15 is packaged through the rear opening 9, and the small-sized sub electronic circuit units 16 are packaged through the front opening 8. Accordingly, the inside space of the casing can be utilized effectively, and the operation efficiency of the process for accommodating the electronic circuit units in the casing can be heightened.

Moreover, in case that the body 4 is molded using the metallic mold, namely, by aluminum die casting or injection molding, the cubic volume of the inside space of the body 4 is decreased because of the tapers formed on the inner surfaces of the body 4 in usual cases. However, according to the invention, since the body 4 is shaped into a tubular configuration having a rectangular cross-section, and decrease of the cubic volume of the body 4 can be disregarded, the inside space of the body 4 can be fully utilized, and the efficiency in accommodating the electronic circuit units 15, 16 in the casing can be heightened.

Moreover, the shapes of the body 4 and the covers 5a, 5b, are never restricted to those described in the above, and can be selected suitably in consideration of the worst conditions caused by wind, rain or snow. Explaining concretely, corners of the body or the covers may be rounded off in consideration of wind pressure or snow lying on the top surface of the casing. The shapes of the body 4 and the covers 5a, 5b may be devised in consideration of the conditions of the actual usage, or of the configurations of the electronic circuit units 15, 16 to be accommodated in the casing.

As mentioned in the above, according to the casing used in the outdoors according to the invention, since the electronic circuit units can be packaged in the body through the front and rear openings, the efficiency in packaging the electronic circuit units in the body can be heightened. Moreover, since the body is shaped into a tubular configuration, the tapers formed on the inner surfaces of the body in the step of molding the body is disregarded. Accordingly, the large-sized electronic circuit units can be packaged in the body without hindrance, and the many electronic circuit units can be accommodated in the casing efficiently.

Moreover, in the casing used in the outdoors according to the invention, since the covers can be opened or shut by rotating the covers around the hinges fitted to the body, the efficiency in operations for packaging the electronic circuit units in the body through the front and rear openings can be heightened. Furthermore, since the supporting members are provided in the inside space of the body and the electronic circuit units can be fitted to the supporting members smoothly, the electronic circuit units can be accommodated in the casing with high efficiency.

What is claimed is:

1. A casing used in an outdoors, comprising:
a body which is provided with one or more suspending means for suspending said body from a wire stretched over a ground, and has openings situated opposite to each other, and
covers for covering said openings of said body.

2. A casing used in an outdoors according to claim 1, wherein:
said body is shaped into a tubular configuration having a predetermined cross-section.

3. A casing used in an outdoors according to claim 1, wherein:
said body is provided with gaskets on contact surfaces which are respectively formed on peripheries of said openings of said body, and brought into contact with said covers.

4. A casing used in an outdoors according to claim 1, wherein:
said covers are respectively fitted to said body via hinges.

5. A casing used in an outdoors according to claim 1, wherein:
said body is provided with supporting members situated in an inside space of said body, and
electronic parts are fitted to said supporting members.

6. A casing used in an outdoors according to claim 5, wherein:
said electronic parts are fitted to said supporting members via fitting boards which can be easily fitted to and removed from said supporting members.

7. A casing used in an outdoors according to claim 1, wherein:
electronic parts are packaged in inside spaces of said covers.
